(19) United States
(12) Patent Application Publication
(10) Pub. No.: US 2021/0101594 A1
(43) Pub. Date: Apr. 8, 2021

(54) VEHICLE DRIVING GUARANTEE METHOD, APPARATUS, DEVICE AND READABLE STORAGE MEDIUM

(71) Applicant: BEIJING BAIDU NETCOM SCIENCE TECHNOLOGY CO., LTD., Beijing (CN)

(72) Inventors: Gao YU, Beijing (CN); Jingjing XUE, Beijing (CN); Shenglin QIN, Beijing (CN); Shi HU, Beijing (CN)

(21) Appl. No.: 17/125,293

(22) Filed: Dec. 17, 2020

Related U.S. Application Data
(63) Continuation of application No. PCT/CN2019/102959, filed on Aug. 28, 2019.

(30) Foreign Application Priority Data
Jan. 15, 2019 (CN) 201910037115.0

(51) Int. Cl. B60W 30/14; G08G 1/09; G08G 1/16; B60W 40/06

(52) U.S. Cl. CPC B60W 30/143; G08G 1/09; G08G 1/164; B60W 2556/45; B60W 2420/52; B60W 2420/42; B60W 40/06

(57) ABSTRACT

The application provides a vehicle driving guarantee method, an apparatus, a device, and a readable storage medium. The method includes: acquiring vehicle state information of a vehicle and current road environment information in real-time; sending the state information of the vehicle and the current road environment information to a monitoring terminal under a condition that the state information of the vehicle meets a preset driving guarantee condition, so that the monitoring terminal generates a control instruction according to a driving strategy after the driving strategy is determined according to the state information of the vehicle and the current road environment information by a monitoring user; and receiving the control instruction returned by the monitoring terminal, and controlling the vehicle to drive according to the control instruction.

### CROSS-REFERENCE TO RELATED APPLICATIONS

This application is a continuation of International Application No. PCT/CN2019/102959, filed on. Aug. 28, 2019, which claims the priority of a Chinese Patent Application No. 201910037115.0, entitled “VEHICLE DRIVING GUARANTEE METHOD, APPARATUS, DEVICE AND READABLE STORAGE MEDIUM” filed to the China National Intellectual Property Administration on Jan. 15, 2019. The disclosures of the aforementioned applications are hereby incorporated by reference in their entireties.

### TECHNICAL FIELD

The present application relates to the technical field of unmanned driving, and in particular to a vehicle driving guarantee method, an apparatus, a device, and a readable storage medium.

### BACKGROUND

With the development of the computer technology and the artificial intelligence, unmanned driving vehicles (abbreviation: unmanned vehicle) have broad application prospects in transportation, military affairs, logistics warehousing and daily life. Unmanned driving technology mainly includes the perception of environmental information, intelligent decision-making of driving behavior, collision-free path planning, and the motion control of the vehicle.

### SUMMARY

In a first aspect, an embodiment of the present application provides a vehicle driving guarantee method, including:

acquiring state information of the vehicle and current road environment information in real-time;

sending the state information of the vehicle and the current road environment information to a monitoring terminal under a condition that the state information of the vehicle meets a preset driving guarantee condition, so that the monitoring terminal generates a control instruction according to a driving strategy after the driving strategy is determined according to the state information of the vehicle and the current road environment information by a monitoring user;

receiving the control instruction returned by the monitoring terminal, and controlling the vehicle to drive according to the control instruction.

In a possible implementation, in the above method provided by an embodiment of this application, the state information of the vehicle itself includes a driving speed of the vehicle;

the sending the state information of the vehicle and the current road environment information to the monitoring terminal under the condition that the state information of the vehicle meets the preset driving guarantee condition specifically includes:

sending the state information of the vehicle and the current road environment information to the monitoring terminal under a condition that the continuous time during which the driving speed of the vehicle is less than a preset speed threshold exceeds a preset time threshold.

In a possible implementation, in the above method provided by an embodiment of this application, the state information of the vehicle itself includes a driving displacement of the vehicle;

the sending the state information of the vehicle and the current road environment information to the monitoring terminal under the condition that the state information of the vehicle meets the preset driving guarantee condition includes:

sending the state information of the vehicle and the current road environment information to the monitoring terminal under a condition that the driving displacement of the vehicle is less than a preset displacement threshold within a preset time period.

In a possible implementation, in the above method provided by an embodiment of the present application, the controlling the vehicle to drive according to the control instruction specifically includes:

controlling the vehicle to drive on a non-congested road section in the current road environment information.

In a possible implementation, in the above method provided by an embodiment of this application, the controlling the vehicle to drive on a non-congested road section in the current road environment information specifically includes:

controlling the vehicle to drive along a road section ahead under a condition that the road section ahead of a current road of the vehicle is a non-congested road section;

controlling the vehicle to drive along a surrounding road section under a condition that the surrounding road section of the current road of the vehicle is a non-congested road section.

In a possible implementation, in the above method provided by an embodiment of this application, the sending the state information of the vehicle and the current road environment information to the monitoring terminal specifically includes:

sending the state information of the vehicle and the current road environment information to a monitoring terminal.

In a second aspect, an embodiment of the present application provides a vehicle driving guarantee method, including:

receiving a driving strategy sent by a monitoring user, where the driving strategy is determined according to state information of a vehicle and current road environment information when the own state information of the vehicle meets a preset driving guarantee condition;

generating a control instruction according to the driving strategy;

sending the control instruction to the vehicle terminal, so that the vehicle terminal controls the vehicle to drive according to the control instruction.

In a possible implementation, in the above method provided by an embodiment of this application, the generating a control instruction according to the driving strategy specifically includes:

generating a corresponding control instruction according to the driving strategy of the vehicle in the non-congested road section in the current road environment information.

In a possible implementation, in the above method provided by an embodiment of this application, generating the corresponding control instruction according to the driving strategy of the vehicle in the non-congested road section in the current road environment information specifically includes:

generating a first control instruction according to the driving strategy of the vehicle in the non-congested road section ahead in the current road environment information;

generating a second control instruction according to the driving strategy of the vehicle in the surrounding non-congested road section in the current road environment information.

In a third aspect, an embodiment of the present application provides a vehicle driving guarantee apparatus, including:

an acquiring module, configured to acquire state information of a vehicle and current road environment information in real-time;

a sending module, configured to send the state information of the vehicle and the current road environment information to a monitoring terminal under a condition that the state information of the vehicle meets a preset driving guarantee condition, so that the monitoring terminal generates a control instruction according to a driving strategy after the driving strategy is determined according to the state information of the vehicle and the current road environment information by a monitoring user;

a receiving and controlling module, configured to receive the control instruction returned by the monitoring terminal, and controlling the vehicle to drive according to the control instruction.

In a fourth aspect, an embodiment of the present application provides a vehicle driving guarantee apparatus, including:

a strategy receiving module, configured to receive a driving strategy sent by a monitoring user, where the driving strategy is determined according to state information of a vehicle and current road environment information when the own state information of the vehicle meets a preset driving guarantee condition;

an instruction generating module, configured to generate a control instruction according to the driving strategy;

an instruction sending module, configured to send the control instruction to the vehicle terminal, so that the vehicle terminal controls the vehicle to drive according to the control instruction.

In a fifth aspect, an embodiments of the present application provides an in-vehicle device, including a memory, a processor, and a computer program;

where, the computer program is stored in the memory and configured to be executed by the processor to implement the method according to the first aspect above.

In a sixth aspect, an embodiment of the present application provides a monitoring device, including: a memory, a processor, and a computer program;

where, the computer program is stored in the memory and configured to be executed by the processor to implement the method according to the second aspect above.

In a seventh aspect, an embodiment of the present application provides a computer-readable storage medium on which a computer program is stored, the program being executed by a processor to realize the method according to the above first aspect.

In an eighth aspect, an embodiment of the present application provides a computer-readable storage medium on which a computer program is stored, the program being executed by a processor to realize the method according to the above second aspect.

### BRIEF DESCRIPTION OF DRAWINGS

FIG. 1 is schematic diagram of a driving environment provided by an embodiment of the application;

FIG. 2 is a flowchart of a vehicle driving guarantee method provided by an Embodiment 1 of the application;

FIG. 3 is a flowchart of a vehicle driving guarantee method provided by an Embodiment 2 of the application;

FIG. 4 is a flowchart of a vehicle driving guarantee method provided by an Embodiment 3 of the application;

FIG. 5 is a schematic structural diagram of a vehicle driving guarantee apparatus provided by an Embodiment 4 of this application;

FIG. 6 is a schematic structural diagram of a vehicle driving guarantee apparatus provided by an Embodiment 6 of the application;

FIG. 7 is a schematic structural diagram of an in-vehicle device provided by an Embodiment 7 of the application; and

FIG. 8 is a schematic structural diagram of a monitoring device provided by an Embodiment 8 of this application.

### DESCRIPTION OF EMBODIMENTS

At least one purpose of the embodiments of the present application is to provide a vehicle driving guarantee method, an apparatus, a device, and a readable storage medium so as to provide guarantee for the normal driving of an unmanned vehicle and improve the driving stability of the vehicle.

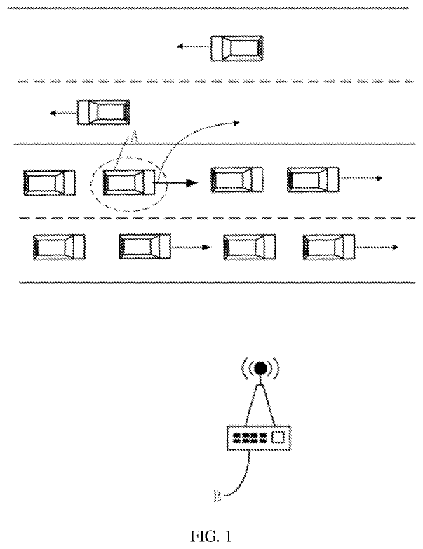

FIG. 1 exemplarily shows a schematic diagram of a driving environment to which the method, the apparatus, device and the readable storage medium according to the embodiments of the present application are applicable. The illustrated scenario is a two-way four-lane environment in which there are many vehicles. The unmanned vehicle of this application is the illustrated vehicle A, and the illustrated B is the monitoring terminal of this application. As shown in this figure, there are more vehicles in the right two lanes where vehicle A is located, which are more congested, while there are fewer vehicles in the left two lanes. Vehicle A is equipped with several cameras, several millimeter wave radars, lidars and other device for automatic driving. A plurality of millimeter wave radars are uniformly distributed around the vehicle body, and at least one lidar is distributed at the center of the vehicle roof to ensure full coverage around the vehicle body. lidar adopts light detection and ranging (LIDAR) technology, and more than one lidar can scan the entire 360-degree field of view more completely and quickly. The camera takes video or image, and millimeter wave radar and lidar measure the distance from other vehicles or obstacles and the moving speed of the obstacles to provide road environment information to the in-vehicle automatic driving system. The automatic driving system generates control information according to information such as the current road condition and distance from moving obstacles, and the control information is applied to various device and components of the automobile to accelerate, decelerate or stop automatic driving.

FIG. 1 exemplarily shows that a vehicle driving on a road will encounter unexpected situations such as road congestion. The existing unmanned vehicle automatic driving system will control the vehicle to stop or drive slowly after making the decision of road congestion, and if the duration is too long, the result such as the unmanned vehicle cannot reach the destination in time will be caused, thus causing corresponding losses. Embodiments of the present application will be specifically described below with reference to the drawings.

### Embodiment 1

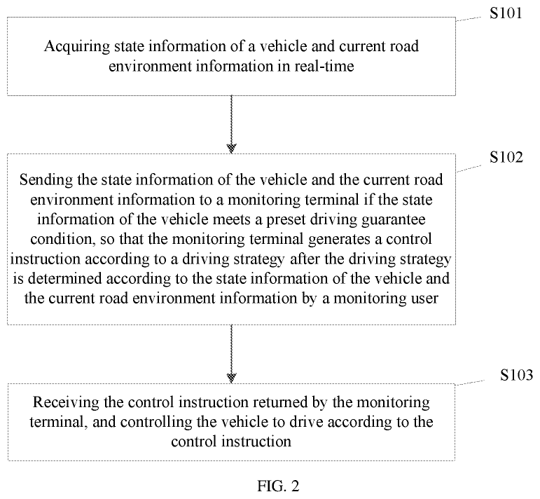

FIG. 2 is a flowchart of a method for guaranteeing the vehicle driving provided by an Embodiment 1 of the application. As shown in FIG. 2, the exemplary executive body of an embodiment of this application is a vehicle driving guarantee device, which can be integrated into an automatic driving system. The vehicle driving guarantee method provided in this embodiment includes the following steps:

S101: acquiring state information of a vehicle and current road environment information in real-time.

In a possible implementation, automatic driving vehicles drive on the current road and can collect and record their state information and current road environment information in real-time through configured cameras, millimeter wave radar and/or lidar and other sensing devices. The state information of the vehicle may include vehicle speed, displacement, various sensing information and decision information made according to the sensing information. The current road environment information may include vehicles or obstacles around the vehicle, traffic lights information and so on.

S102: sending the state information of the vehicle and the current road environment information to a monitoring terminal if the state information of the vehicle meets a preset driving guarantee condition, so that the monitoring terminal generates a control instruction according to a driving strategy after the driving strategy is determined according to the state information of the vehicle and the current road environment information by a monitoring user.

In a possible implementation, sending the state information of the vehicle and current road environment information to the monitoring terminal if at least one of the vehicle speed, displacement, various sensing information and decision information made according to the sensing information meets the preset driving guarantee condition is detected. For example, according to an exemplary implementation of an embodiment, the preset driving guarantee condition may be that the vehicle speed is low for a long time. According to another exemplary implementation of the embodiment of the present application, the preset driving guarantee condition may be that the displacement of the vehicle changes little within a period of time. According to another exemplary implementation of the embodiment of the present application, the preset driving guarantee condition may be that the decision information made by the vehicle according to the sensing information has more abnormal situations.

Further, the monitoring user of the monitoring terminal can comprehensively judge the current state of the vehicle itself and the real environment it is in according to the received state information of the vehicle and the current road environment information, so as to make a driving strategy that enables the vehicle to cope with the current emergency situation in time and accurately. For example, if it is detected that the speed and displacement of the vehicle meet the preset driving guarantee conditions, it is often because the automatic driving system has made decisions such as current road congestion or the existence of abnormal obstacles. However, there may be two reasons for the actual situation, one of which is that the current road is indeed congested and cannot be automatically bypassed, and the other is that the vehicle's sensing system is faulty, which cannot timely and accurately recognize obstacles or sense errors. Therefore, when the preset driving guarantee condition is met, the state information of the vehicle and the current road environment information are sent to the monitoring terminal, and the monitoring user can determine the driving strategy timely and accurately. If the current road is indeed congested, a driving strategy for controlling the vehicle to drive to the non-congested road section is made according to the current road environment information. If the sensing system of the vehicle can't timely and accurately recognize the current obstacle or recognize the error, it can control the vehicle to continue to drive normally to pass through the area where the current recognition is wrong or update the error software in the automatic driving system, and resume normal driving after updating. The monitoring terminal generates the corresponding control instruction according to the determined driving strategy and returns it to the vehicle.

S103: receiving the control instruction returned by the monitoring terminal, and controlling the vehicle to drive according to the control instruction.

In a possible embodiment, the vehicle receives the control instruction returned by the monitoring terminal and controls the vehicle to drive according to the control instruction. For example, controlling the vehicle to drive to a non-congested road section or continue to drive normally.

By acquiring state information of a vehicle and current road environment information in real-time; sending the state information of the vehicle and the current road environment information to a monitoring terminal if the state information of the vehicle meets a preset driving guarantee condition, so that the monitoring terminal generates a control instruction according to a driving strategy after the driving strategy is determined according to the state information of the vehicle and the current road environment information by a monitoring user; and receiving the control instruction returned by the monitoring terminal, and controlling the vehicle to drive according to the control instruction, the vehicle can timely deal with unexpected situations such as road congestion according to the control instruction, and guarantee that the vehicle can reach the destination in time and stably, thus avoiding certain economic losses.

### Embodiment 2

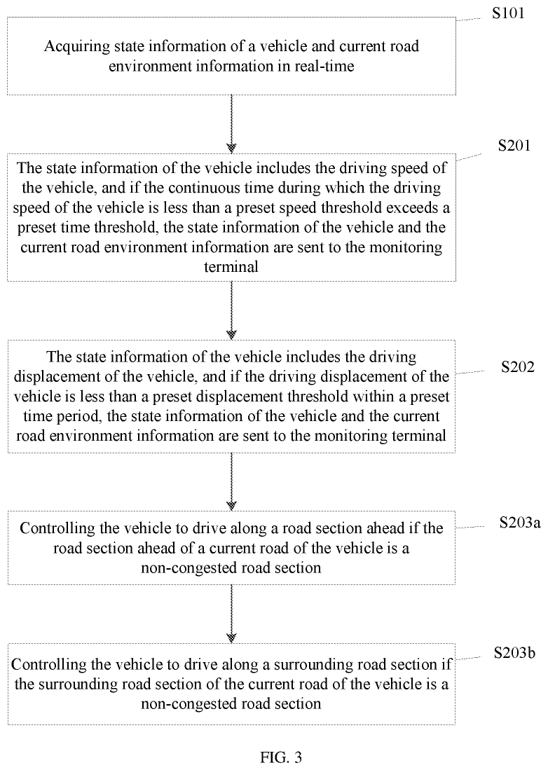

FIG. 3 is a flowchart of a vehicle driving guarantee method provided by an Embodiment 2 of the application. As shown in FIG. 3, the vehicle driving guarantee method exemplarily provides a possible implementations of steps 102 and 103 based on the method embodiment 1 of the present application:

For example, the above step 102 can be implemented through step 201 and/or step 202:

S201: the state information of the vehicle includes the driving speed of the vehicle, and if the continuous time during which the driving speed of the vehicle is less than a preset speed threshold exceeds a preset time threshold, the state information of the vehicle and the current road environment information are sent to the monitoring terminal.

For example, the preset speed threshold is 10 km/h, and the preset time threshold is 10 minutes. As shown in FIG. 1, if the driving speed of vehicle A has exceeded 10 minutes and is below 10 km/h, the state information of the vehicle A and the current road environment information are sent to the monitoring terminal B.

Step 202: the state information of the vehicle includes the driving displacement of the vehicle, and if the driving displacement of the vehicle is less than a preset displacement threshold within a preset time period, the state information of the vehicle and the current road environment information are sent to the monitoring terminal.

For example, the preset time period is 10 minutes, and the preset displacement threshold is 1 km. As shown in FIG. 1, if the driving displacement of the vehicle A within 10 minutes is less than 1 km, the state information of the vehicle and the current road environment information are sent to the monitoring terminal.

Among them, in a feasible implementation manner, a point-to-point network may be used to send the state information of the vehicle and current road environment information to the monitoring terminal. For example, an unmanned vehicle and a monitoring terminal form a point-to-point network and the unmanned vehicle can directly communicate with the monitoring terminal through the 4G/5G network without transferred by the server, thereby reducing information transmission delay and improving communication efficiency.

The above step 103 of the example may be implemented by the following method:

Step 203: controlling the vehicle to drive on a non-congested road section in the current road environment information.

In an implementation manner, step 203 may include:

Step 203a: controlling the vehicle to drive along a road section ahead if the road section ahead of a current road of the vehicle is a non-congested road section.

Among them, if the road section ahead of a current road of the vehicle is a non-congested road section, it means that the sensing system of vehicle misreported, resulting in vehicle decision-making errors. And the reason for the misreporting of the sensing system may be the software and hardware failure of the sensing system or the failure of the sensing system for the current road section. In the above case, the vehicle can be controlled to continue driving along the road section ahead.

Step 203b: controlling the vehicle to drive along a surrounding road section if the surrounding road section of the current road of the vehicle is a non-congested road section.

Among them, if only the surrounding road section in the current road environment information of the vehicle are non-congested road section, it means that the current road is indeed congested, and the vehicle can be controlled to drive along the surrounding non-congested road section and resume automatic driving after bypassing the congested road section.

By acquiring vehicle state information of a vehicle and current road environment information in real-time, sending the state information of the vehicle and the current road environment information to a monitoring terminal by using a point-to-point network if the continuous time during which the driving speed of the vehicle is less than a preset speed threshold exceeds a preset time threshold or if the driving displacement of the vehicle is less than a preset displacement threshold within a preset time period, so that the monitoring terminal generates a control instruction according to a driving strategy after the driving strategy is determined according to the state information of the vehicle and the current road environment information by a monitoring user; and receiving the control instruction returned by the monitoring terminal, and controlling the vehicle to drive according to the control instruction, the vehicle can timely deal with unexpected situations such as road congestion according to the control instruction, and guarantee that the vehicle can reach the destination in time and stably, thus avoiding certain economic losses.

### Embodiment 3

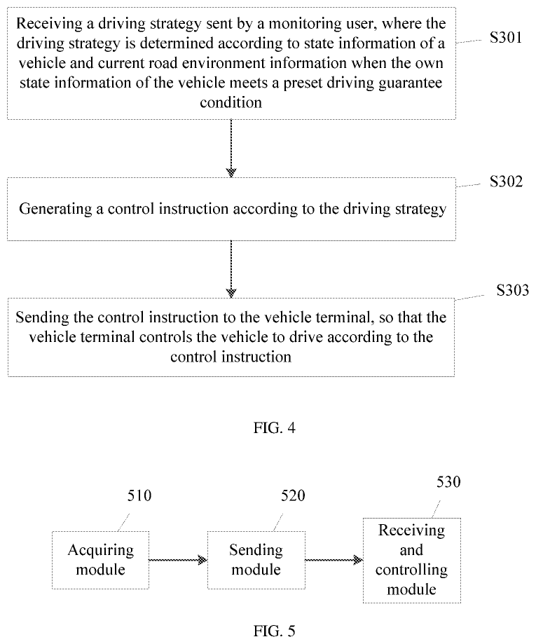

FIG. 4 is a flowchart of a vehicle driving guarantee method provided by Embodiment 3 of the application. As shown in FIG. 4, the exemplary executive body of an embodiment of this application can be a vehicle driving guarantee device, which can be integrated in a monitoring terminal. The vehicle driving guarantee method provided in this embodiment includes the following steps:

S301: receiving a driving strategy sent by a monitoring user, where the driving strategy is determined according to state information of a vehicle and current road environment information when the own state information of the vehicle meets a preset driving guarantee condition.

For example, the monitoring user of the monitoring terminal can comprehensively judge the current state of the vehicle itself and the real environment it is in according to the received state information of the vehicle and the current road environment information, so as to make a driving strategy that enables the vehicle to cope with the current emergency situation in time and accurately. For example, if it is detected that the speed and displacement of the vehicle meet the preset driving guarantee conditions, it is often because the automatic driving system has made decisions such as current road congestion or the existence of abnormal obstacles. However, there may be two reasons for the actual situation, one of which is that the current road is indeed congested and cannot be automatically bypassed, and the other is that the vehicle's sensing system is faulty, which cannot timely and accurately recognize obstacles or sense errors. Therefore, when the preset driving guarantee condition is met, the state information of the vehicle and the current road environment information are sent to the monitoring terminal, and the monitoring user can determine the driving strategy timely and accurately. If the current road is indeed congested, a driving strategy for controlling the vehicle to drive to the non-congested road section is made according to the current road environment information. If the sensing system of the vehicle can't timely and accurately recognize the current obstacle or recognize the error, it can control the vehicle to continue to drive normally to pass through the area where the current recognition is wrong or update the error software in the automatic driving system, and resume normal driving after updating. The monitoring terminal generates the corresponding control instruction according to the determined driving strategy and returns it to the vehicle.

Step 302: generating a control instruction according to the driving strategy.

For example, if the current road is indeed congested, a control instruction for controlling the vehicle to driving to the non-congested road section is generated according to the above driving strategy. If the sensing system of the vehicle can't timely and accurately recognize the current obstacle or recognize the error, the generated control instruction may be controlling the vehicle to continue to drive normally to pass through the currently recognized wrong area or updating the error software in the automatic driving system, and resuming normal driving after updating.

Step 303: sending the control instruction to the vehicle terminal, so that the vehicle terminal controls the vehicle to drive according to the control instruction.

In an example, the monitoring terminal generates a corresponding control instruction according to the determined driving strategy and returns it to the vehicle, and the vehicle terminal controls the vehicle to drive according to the returned control instruction.

By receiving the driving strategy sent by the monitoring user, generating a control instruction according to the driving strategy; sending the control instruction to the vehicle terminal, so that the vehicle terminal controls the vehicle to drive according to the control instruction, the vehicle can be enabled to timely deal with unexpected situations such as road congestion according to the control instruction, and ensure that the vehicle can reach the destination in time and stably, thus avoiding certain economic losses.

According to an implementation manner of the embodiment of the present application, the above step 302 may specifically be:

S401: generating a corresponding control instruction according to a driving strategy of the vehicle on a non-congested road section in the current road environment information.

In an implementation manner, step 401 may include:

Step 401a: generating a first control instruction according to the driving strategy of the vehicle on a non-congested road section ahead in the current road environment information.

Among them, if the road ahead in the current road environment information is a non-congested road section, it means that the vehicle sensing system is faulty, and a control instruction is generated to control the vehicle to continue driving normally on the road ahead.

S401b: generating a second control instruction according to the driving strategy of the vehicle on the surrounding non-congested road section in the current road environment information.

Among them, if only the surrounding road in the current road environment information are non-congested road section, a control instruction for controlling the vehicle to bypass the surrounding non-congested road section to pass through the congested road section ahead is generated.

### Embodiment 4

FIG. 5 is a schematic structural diagram of a vehicle driving guarantee apparatus provided by Embodiment 4 of this application, as shown in FIG. 5, the apparatus provided in this embodiment includes:

an acquiring module 510, configured to acquire state information of a vehicle and current road environment information in real-time;

a sending module 520, configured to send the state information of the vehicle and the current road environment information to a monitoring terminal if the state information of the vehicle meets a preset driving guarantee condition, so that the monitoring terminal generates a control instruction according to a driving strategy after the driving strategy is determined according to the state information of the vehicle and the current road environment information by a monitoring user;

a receiving and controlling module 530, configured to receive the control instruction returned by the monitoring terminal, and controlling the vehicle to drive according to the control instruction.

The device provided in this embodiment can execute the technical solution of the method embodiment shown in FIG. 2, and its implementation principles and technical effect are similar, and will not be repeated here.

### Embodiment 5

The apparatus provided in this embodiment is based on the apparatus provided in Embodiment 4 of this application. Furthermore, according to a implementation manner of this application, the state information of the vehicle includes the driving speed of the vehicle, the sending module 520 may be configured to send the state information of the vehicle and the current road environment information to the monitoring terminal if the continuous time during which the driving speed of the vehicle is less than a preset speed threshold exceeds a preset time threshold.

According to an implementation manner of this embodiment, the state information of the vehicle includes the driving displacement of the vehicle, the sending module 520 is configured to send the state information of the vehicle and the current road environment information to the monitoring terminal if the driving displacement of the vehicle is less than a preset displacement threshold within a preset time period.

According to an implementation manner of this embodiment, the receiving and controlling module 530 is specifically configured to control the vehicle to drive on a non-congested road section in the current road environment information.

The receiving control module 530 is configured to: control the vehicle to drive along a road section ahead if the road section ahead of a current road of the vehicle is a non-congested road section, control the vehicle to drive along a surrounding road section if the surrounding road section of the current road of the vehicle is a non-congested road section.

According to an implementation manner of this embodiment, the sending module 520 is configured to send the state information of the vehicle and current road environment information to the monitoring terminal by using a point-to-point network.

The apparatus provided in this embodiment can implement the technical scheme of the method embodiment shown in FIG. 3, and its implementation principle and technical effect are similar, so it will not be repeated here.

### Embodiment 6

FIG. 6 is a schematic structural diagram of a vehicle driving guarantee apparatus provided by Embodiment 6 of this application. As shown in FIG. 6, the apparatus provided in this embodiment includes:

a strategy receiving module 610, configured to receive a driving strategy sent by a monitoring user, where the driving strategy is determined according to state information of a vehicle and current road environment information when the own state information of the vehicle meets a preset driving guarantee condition;

an instruction generating module 620, configured to generate a control instruction according to the driving strategy;

an instruction sending module 630, configured to send the control instruction to the vehicle terminal, so that the vehicle terminal controls the vehicle to drive according to the control instruction.

According to an implementation manner of this embodiment, the instruction generation module 630 is configured to:

generate the corresponding control instruction according to the driving strategy of the vehicle on the non-congested road section in the current road environment information.

The instruction generation module 630 is configured to:

generate a first control instruction according to the driving strategy of the vehicle in the front non-congested road section in the current road environment information, and generate a second control instruction according to the driving strategy of the vehicle in the surrounding non-congested road section in the current road environment information.

The apparatus provided in this embodiment can implement the technical scheme of the method embodiment shown in FIG. 4, and its implementation principle and technical effect are similar, so it will not be repeated here.

### Embodiment 7

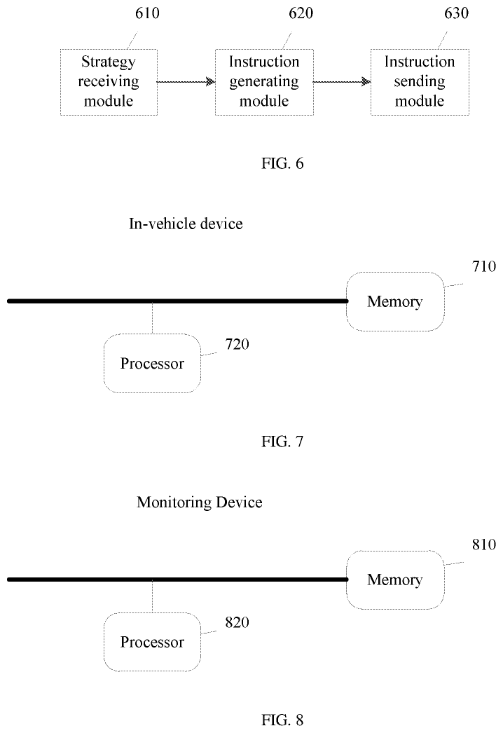

FIG. 7 is a schematic structural diagram of an in-vehicle device provided by Embodiment 7 of the application. As shown in FIG. 7, the in-vehicle device provided in this embodiment includes a memory 710, a processor 720, and a computer program;

Among them, the computer program is stored in the memory 710 and is configured to be executed by the processor 720 to realize the vehicle driving guarantee method in Embodiment 1 or Embodiment 2.

The related description may be understood by referring to the related description and effect corresponding to the steps in FIG. 2 to FIG. 3, and will not be repeated here.

### Embodiment 8

FIG. 8 is a schematic structural diagram of a monitoring device provided by Embodiment 8 of this application. As shown in FIG. 8, the monitoring device provided by this embodiment includes: a memory 810, a processor 820, and a computer program;

Where, the computer program is stored in the memory 810 and is configured to be executed by the processor 820 to realize the vehicle driving guarantee method in embodiment 3 of the present application.

The related description may be understood by referring to the related description and effect corresponding to the steps in FIG. 4, and the details are not repeated here.

### Embodiment 9

The Embodiment 9 of the present application also provides a computer-readable storage medium on which a computer program is stored, and the program is executed by the processor to realize the vehicle driving guarantee method in the Embodiment 1 or the Embodiment 2 of the present application.

By acquiring state information of a vehicle and current road environment information in real-time; sending the state information of the vehicle and the current road environment information to a monitoring terminal if the state information of the vehicle meets a preset driving guarantee condition, so that the monitoring terminal generates a control instruction according to a driving strategy after the driving strategy is determined according to the state information of the vehicle and the current road environment information by a monitoring user; and receiving the control instruction returned by the monitoring terminal, and controlling the vehicle to drive according to the control instruction, the vehicle can timely deal with unexpected situations such as road congestion according to the control instruction, and guarantee that the vehicle can reach the destination in time and stably, thus avoiding certain economic losses.

### Embodiment 10

The Embodiment 10 of the present application also provides a computer-readable storage medium on which a computer program is stored, and the program is executed by the processor to realize the vehicle driving guarantee method in the Embodiment 3 of the present application.

By receiving the driving strategy sent by the monitoring user, generating a control instruction according to the driving strategy; sending the control instruction to the vehicle terminal, so that the vehicle terminal controls the vehicle to drive according to the control instruction, the vehicle can be enabled to timely deal with unexpected situations such as road congestion according to the control instruction, and ensure that the vehicle can reach the destination in time and stably, thus avoiding certain economic losses.

In the several embodiments provided in this application, it should be understood that the disclosed apparatus and method may be realized in other ways. For example, the apparatus embodiments described above are merely illustrative; for example, the division of modules is only a logical function division, and there may be another division mode in actual implementation; for example, multiple modules or components can be combined or integrated into another system, or some features may be ignored, or not executed. On the other hand, the mutual coupling or direct coupling or communication connection shown or discussed may be indirect coupling or communication connection through some interfaces, apparatuses or modules, and may be in electrical, mechanical or other forms.

The modules described as separate components may or may not be physically separated, and the components displayed as modules may or may not be physical modules, that is, they may be located in one place, or distributed on multiple network modules. Some or all of the modules may be selected according to actual needs to achieve the purpose of this embodiment.

In addition, each functional module in each embodiment of the present application may be integrated into one processing module, or each module may exist physically alone, or two or more modules may be integrated into one module. The above integrated modules may be implemented in the form of hardware, or in the form of hardware plus software functional modules.

The program code for implementing the method of the present application may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program code can be executed completely on the machine, partially on the machine, partially on the machine as an independent software package and partially on a remote machine or completely on a remote machine or server.

In the context of the present application, a machine-readable medium may be a tangible medium that may contain or store a program for use by or in connection with an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor system, apparatus or device, or any suitable combination of the above. More specific examples of machine-readable storage media may include electrical connections based on one or more wires, portable computer disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In addition, although the operations are depicted in a specific order, this should be understood as requiring such operations to be performed in the specific order shown or in a sequential order, or requiring that all illustrated operations should be performed to obtain desired results. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single implementation. Conversely, a single implementation of the various features described in the context can also be implemented individually in multiple implementations or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. A vehicle driving guarantee method, comprising:
acquiring state information of a vehicle and current road environment information in real-time;
sending the state information of the vehicle and the current road environment information to a monitoring terminal under a condition that the state information of the vehicle meets a preset driving guarantee condition, so that the monitoring terminal generates a control instruction according to a driving strategy after the driving strategy is determined according to the state information of the vehicle and the current road environment information by a monitoring user; and
receiving the control instruction returned by the monitoring terminal, and controlling the vehicle to drive according to the control instruction.

2. The method according to the claim 1, wherein the state information of the vehicle of the vehicle comprises a driving speed of the vehicle;
wherein the sending the state information of the vehicle and the current road environment information to the monitoring terminal under the condition that the state information of the vehicle meets the preset driving guarantee condition comprises:
sending the state information of the vehicle and the current road environment information to the monitoring terminal under a condition that the continuous time during which the driving speed of the vehicle is less than a preset speed threshold exceeds a preset time threshold.

3. The method according to the claim 1, wherein the state information of the vehicle of the vehicle comprises a driving displacement of the vehicle;
wherein the sending the state information of the vehicle and the current road environment information to the monitoring terminal under the condition that the state information of the vehicle meets the preset driving guarantee condition comprises:
sending the state information of the vehicle and the current road environment information to the monitoring terminal under a condition that the driving displacement of the vehicle is less than a preset displacement threshold within a preset time period.

4. The method according to the claim 2, wherein the controlling the vehicle to drive according to the control instruction comprises:
controlling the vehicle to drive on a non-congested road section in the current road environment information.

5. The method according to the claim 4, wherein the controlling the vehicle to drive on a non-congested road section in the current road environment information comprises:
controlling the vehicle to drive along a road section ahead under a condition that the road section ahead of a current road of the vehicle is a non-congested road section;
controlling the vehicle to drive along a surrounding road section under a condition that the surrounding road section of the current road of the vehicle is a non-congested road section.

6. The method according to the claim 1, wherein the sending the state information of the vehicle and the current road environment information to the monitoring terminal comprises:
sending the state information of the vehicle and the current road environment information to a monitoring terminal by using a point-to-point network.

7. A vehicle driving guarantee method, comprising:
receiving a driving strategy sent by a monitoring user, wherein the driving strategy is determined according to state information of a vehicle and current road environment information when the own state information of the vehicle meets a preset driving guarantee condition;
generating a control instruction according to the driving strategy; and
sending the control instruction to the vehicle terminal, so that the vehicle terminal controls the vehicle to drive according to the control instruction.

8. The method of the claim 7, wherein the generating a control instruction according to the driving strategy comprises:
generating a control instruction for controlling the vehicle to drive along a non-congested road section when the driving strategy is driving along the non-congested road section in the current road environment information.

9. The method according to the claim 8, generating a control instruction for controlling the vehicle to drive along a non-congested road section when the driving strategy is driving along the non-congested road section in the current road environment information comprises:
generating a first control instruction for controlling the vehicle to drive along a road section ahead of the current road according to a driving strategy of the vehicle on a non-congested road section ahead in the current road environment information; or
generating a second control instruction for controlling the vehicle to drive along a surrounding uncongested road section according to a driving strategy of the vehicle on the surrounding non-congested road section in the current road environment information.

10. A vehicle driving guarantee apparatus, comprising a memory, a processor, and a computer program;
wherein the computer program is stored in the memory and configured to be executed by the processor to implement the following steps:
acquiring state information of a vehicle and current road environment information in real-time;
sending the state information of the vehicle and the current road environment information to a monitoring terminal under a condition that the state information of the vehicle meets a preset driving guarantee condition, so that the monitoring terminal generates a control instruction according to a driving strategy after the driving strategy is determined according to the state information of the vehicle and the current road environment information by a monitoring user; and
receiving the control instruction returned by the monitoring terminal, and controlling the vehicle to drive according to the control instruction.

11. The apparatus according to the claim 10, wherein the state information of the vehicle of the vehicle comprises a driving speed of the vehicle;
wherein the computer program is further configured to be executed by the processor to implement the following step:
sending the state information of the vehicle and the current road environment information to the monitoring terminal under a condition that the continuous time during which the driving speed of the vehicle is less than a preset speed threshold exceeds a preset time threshold.

12. The apparatus according to the claim 10, wherein the state information of the vehicle of the vehicle comprises a driving displacement of the vehicle;
wherein the computer program is further configured to be executed by the processor to implement the following step:
sending the state information of the vehicle and the current road environment information to the monitoring terminal under a condition that the driving displacement of the vehicle is less than a preset displacement threshold within a preset time period.

13. The apparatus according to the claim 11, wherein the computer program is further configured to be executed by the processor to implement the following step:
controlling the vehicle to drive on a non-congested road section in the current road environment information.

14. The apparatus according to the claim 13, wherein the computer program is further configured to be executed by the processor to implement the following steps:
controlling the vehicle to drive along a road section ahead under a condition that the road section ahead of a current road of the vehicle is a non-congested road section;
controlling the vehicle to drive along a surrounding road section under a condition that the surrounding road section of the current road of the vehicle is a non-congested road section.

15. The apparatus according to the claim 10, wherein the computer program is further configured to be executed by the processor to implement the following step:
sending the state information of the vehicle and the current road environment information to a monitoring terminal by using a point-to-point network.

16. An in-vehicle device, comprising: a memory, a processor, and a computer program;
wherein the computer program is stored in the memory and configured to be executed by the processor to implement the method according to claim 1.

17. A monitoring device, comprising: a memory, a processor and a computer program;
wherein the computer program is stored in the memory, and is configured to be executed by the processor to implement the method according to claim 7.

18. A computer-readable storage medium with a computer program stored, characterized in that the program is executed by the processor to implement the method according to claim 1.

19. A computer-readable storage medium with a computer program stored, characterized in that the program is executed by the processor to implement the method according to claim 7.
